(19) United States
(12) Patent Application Publication
(10) Pub. No.: US 2007/0231779 A1
(43) Pub. Date: Oct. 4, 2007

(54) Systems and Methods for Simulation of Organ Dynamics

(75) Inventors: Anand P. Santhanam, Orlando, FL (US); Jannick Rolland, Chuluota, FL (US); Cali M. Fidopiastis, Orlando, FL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: University of Central Florida Research Foundation, Inc., Orlando, FL (US)

(21) Appl. No.: 11/674,876

(22) Filed: Feb. 14, 2007

Related U.S. Application Data
(60) Provisional application No. 60/773,486, filed on Feb. 15, 2006.

(51) Int. Cl. G09B 23/28

(52) U.S. Cl. 434/262

(57) ABSTRACT

In one embodiment, a method for simulating organ dynamics includes generating a sequence of three-dimensional models of an organ during different stages of observed dynamic motion, generating a deformation transfer function from the sequence of three-dimensional models, generating a pressure-volume curve from the sequence of three-dimensional models, and generating an organ deformation model that simulates dynamic motion of the organ.

### CROSS-REFERENCE TO RELATED APPLICATION

This application claims priority to copending U.S. provisional application Ser. No. 60/773,486 entitled “OPTICAL APPARATUSES AND METHODS,” which was filed Feb. 15, 2006, and which is entirely incorporated herein by reference.

### BACKGROUND

Medical imaging provides numerous benefits in relation to patient diagnosis and treatment. Despite those benefits, inherent drawbacks exist. For example, in typical cases, only discrete sets of still images or highly isolated real-time images are generated that are dependent of the position of a transducer or other image gathering device. Additionally, the discrete nature of the images does not permit more advanced visualization paradigms, such as a virtual reality, to enable the development of advanced patient education tools and surgical simulators. Further, current imaging technologies do not provide a predictive component regarding the motion of a specific organ, such as a lung during the patient breathing. For example, the motion of a lung tumor will vary during breathing depending on many variables including, for example, the body position or the rate of respiration.

### SUMMARY

The disclosure pertains to systems and method for simulating organ dynamics. In one embodiment, a method for simulating organ dynamics comprises generating a time sequence of three-dimensional models of an organ during different stages of observed dynamic motion, generating a deformation transfer function from the time sequence of three-dimensional models, generating a pressure-volume curve from the sequence of three-dimensional models, and generating an organ deformation model that simulates dynamic motion of the organ.

### BRIEF DESCRIPTION OF THE FIGURES

The components in the drawings are not necessarily to scale, emphasis instead being placed upon clearly illustrating the principles of the present disclosure. In the drawings, like reference numerals designate corresponding parts throughout the several views.

FIG. 1 is a schematic view of an embodiment of apparatus that can be used to capture images of an organ, generate three-dimensional models of the organ, and simulate dynamics of the organ.

FIG. 2 is a block diagram of an embodiment of architecture of a computing device shown in FIG. 1.

FIG. 3 is a flow diagram of an embodiment of a method for generating three-dimensional models of an organ for which dynamic motion is to be simulated.

FIG. 4 is schematic view of a three-dimensional model generated using the method of FIG. 3.

FIG. 5 is a flow diagram of an embodiment of a method for simulating dynamic motion of the lungs.

FIGS. 6A and 6B provide a flow diagram of an embodiment of a method for generating a deformation transfer function.

FIG. 7 is a flow diagram of an embodiment of a method for approximating displacement of nodes of three-dimensional lung models.

FIG. 8 is a schematic depiction of a coordinate system for vertices of the three-dimensional lung models.

FIG. 9 is schematic depiction of spherical parameterization of the vertices of an initial state lung model.

FIG. 10 is a flow diagram of an embodiment of a method for generating a pressure-volume curve.

FIG. 11 is a flow diagram of an embodiment of a method for generating a lung deformation model.

### DETAILED DESCRIPTION

As described above, there are various limitations to current medical imaging techniques, one such limitation being the inability to predict the dynamic motion of an organ. Disclosed herein, however, are systems and methods that can be used to real-time simulate organ dynamics in three-dimensions.

In some embodiments, the systems and methods can be used to simulate dynamic motion of human lungs. To create such a simulation, images of the lungs of a subject are captured during breathing and are used to generate a three-dimensional lung model. As described in greater detail below, the lung model can then be used to generate a deformation transfer function and a pressure-volume curve. Once the deformation transfer function and the pressure-volume curve are generated, they can be used to generate dynamic lung models for various instances of time.

Although simulation of lung dynamics is described with specificity in this disclosure, it is to be appreciated that the disclosed systems and methods can be extended to evaluate other organs, and substantially any body that is subject to dynamic motion. Furthermore, although particular embodiments of systems and methods are described in the following, those embodiments are mere examples. All such embodiments are intended to fall within the scope of this disclosure and are not intended to limit the breadth of the disclosure.

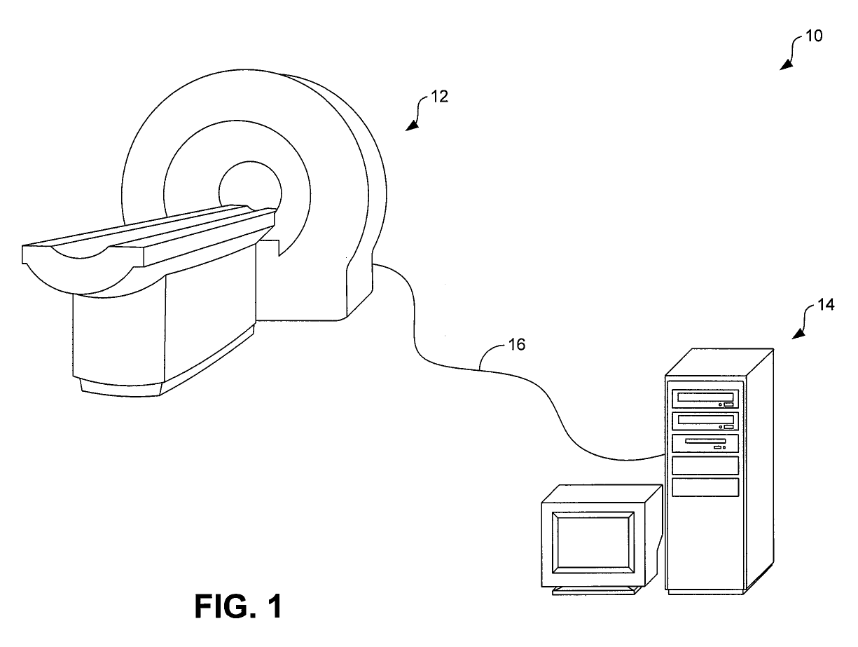

Beginning with FIG. 1, illustrated is example apparatus 10 that can be used to capture images of an organ to be simulated, such as the lungs. As shown in the figure, the apparatus 10 generally includes an image capture device 12 and a computing device 14 that is placed in communication with the image capture device, for example via a cable 16. By way of example, the image capture device 12 comprises a computed tomography (CT) scanner, an ultrasound scanner, or a magnetic resonance imaging (MRI) scanner. The computing device 10 collects images captured by the image capture device 12 and uses those images to generate three-dimensional models of the organ that is to be simulated. One or more programs on the computing device 14 then use the models to generate organ deformation models, examples of which are described below. By way of example, the computing device 14 comprises a desktop computer, a laptop computer, or any other computing device that comprises the processing power and/or memory capacity to generate the aforementioned models.

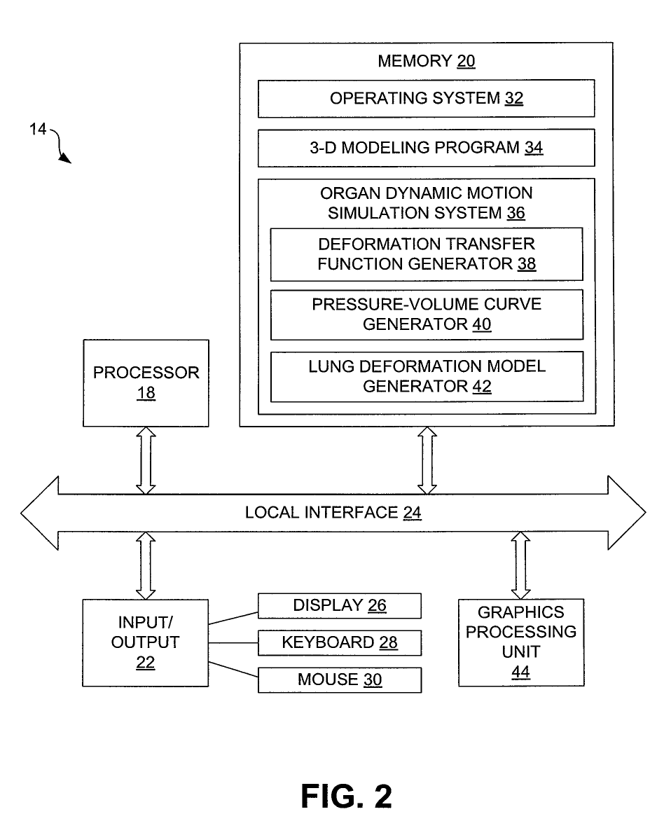

FIG. 2 illustrates an example architecture for the computing device 14 shown in FIG. 1. As indicated in FIG. 2, the computing device 14 generally comprises a processor 18, memory 20, and one or more input/output (I/O) devices 22, each of which is connected to a local interface 24.

The processor 18 can include any commercially-available or custom-made processor, a central processing unit (CPU), an auxiliary processor among several processors associated with the computing device 14, or a semiconductor-based microprocessor (in the form of a microchip). The memory 20 can include any one or a combination of volatile memory elements (e.g., random access memory (RAM)) and nonvolatile memory elements (e.g., hard disk, compact disc (CD), flash memory, etc.).

The I/O devices 22 comprise those components with which a user can interact with the computing device 14, such as a display 26, keyboard 28, and a mouse 30, as well as the components that are used to facilitate connection of the computing device to other devices (e.g., serial, parallel, small computer system interface (SCSI), or universal serial bus (USB) connection ports).

Stored within memory 20 are various programs, in software and/or firmware, including an operating system (O/S) 32, a three-dimensional modeling program 34, and an organ dynamic motion simulation system 36. The O/S 32 controls the execution of other programs and provides scheduling, input-output control, file and data management, memory management, and communication control and related services. The three-dimensional modeling program 34 receives images captured by an image capture device and combines the images to generate three-dimensional models of the organ. The organ dynamic motion simulation system 36 comprises a deformation transfer function generator 38 that generates a deformation transfer function, a pressure-volume curve generator 40 that generates pressure-volume curve, and a lung deformation model generator 42 that generates and renders a lung deformation model using the deformation transfer function and the pressure-volume curve.

In some embodiments, the computing device 14 further comprises a graphics processing unit 44 that, as described below, can be used to render a lung deformation model on the display 26.

Various programs comprising various logic have been described above. Those programs can be stored on any computer-readable medium for use by or in connection with any computer-related system or method. In the context of this document, a computer-readable medium is an electronic, magnetic, optical, or other physical device or means (e.g., memory) that can contain or store computer instructions for use by or in connection with a computer-related system or method.

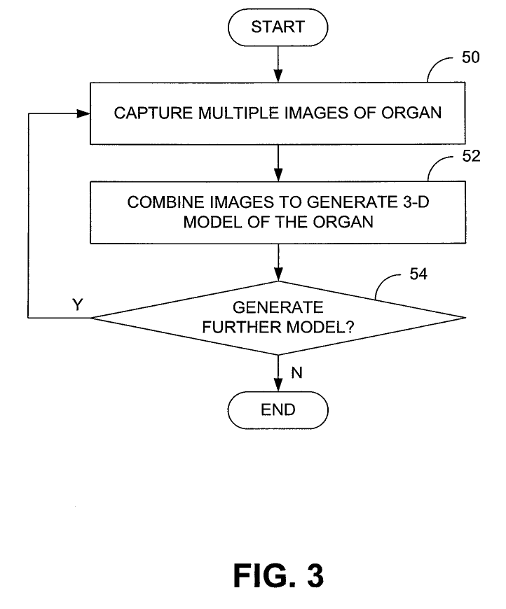

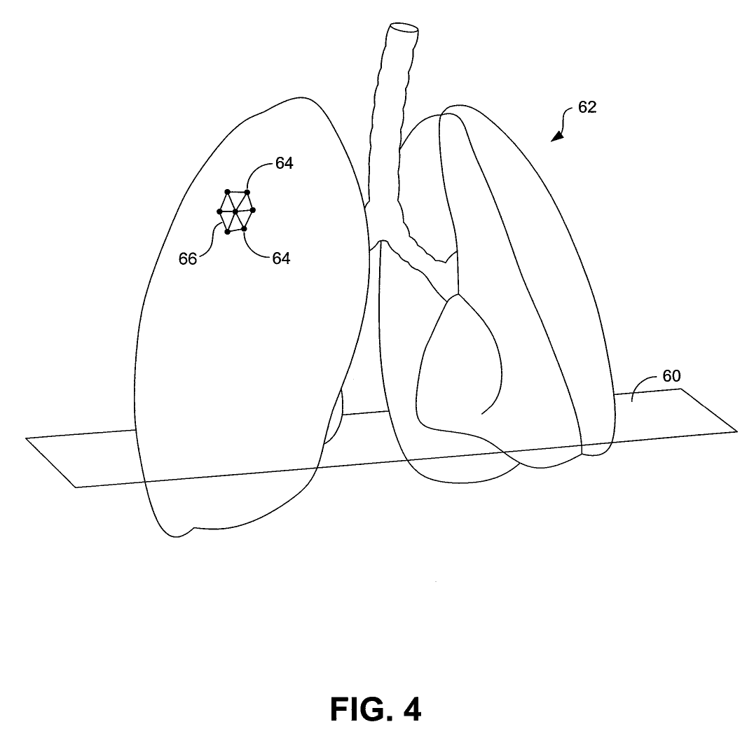

Turning to FIG. 3, illustrated is an embodiment of a method for generating three-dimensional models of an organ at various stages of deformation. By way of example, the method is performed, at least in part, by the three-dimensional modeling program 34 (FIG. 2). Beginning with block 50 of FIG. 3, multiple images of an organ whose motion is to be simulated are captured. In some embodiments, the images comprise multiple CT images that are captured by a CT scanner at different points along the organ. In such a case, the images comprise two-dimensional cross-sectional images of the organ, for example along a transverse plane of a human subject. FIG. 4 schematically illustrates one such image or plane 60 in an embodiment in which the organ comprises the lungs.

Once the images have been captured, they can be combined to form a three-dimensional model of the organ, as indicated in block 52 of FIG. 3. In the example of FIG. 4, a three-dimensional lung model 62 has been generated. Although both lungs, the trachea, and the bronchial tubes are illustrated in FIG. 4 to provide points of reference, it is noted that not all of those organs need be modeled. For example, only a single lung may be modeled in some embodiments. The three-dimensional model 62 can comprise a polygonal model comprising a plurality of surface nodes 64 that are interconnected by a plurality links 66 (only a few nodes and links depicted in FIG. 4 for purposes of example).

Referring next to decision block 54 of FIG. 3, it can be determined whether a further model is to be generated. In cases in which, as in FIG. 4, the one or more lungs are being modeled, separate models can be generated for each of multiple different stages of the subject's breathing. For example, an initial model can be generated at a time “0” at which the patient has fully exhaled and momentarily holds his or her breath. A second model can then be generated at a later time “1” at which the patient has begun to inhale and then momentarily holds his or her breath again, and so forth. In some embodiments, multiple models can be generated for the entire inhalation and/or exhalation process so as to obtain sequential three-dimensional models of each stage of a duration of the subject's breathing. Returning to FIG. 3, if a further three-dimensional model is to be constructed, flow returns to block 50 described above. Once every desired three-dimensional model has been generated, however, flow for this stage of the simulation process is terminated.

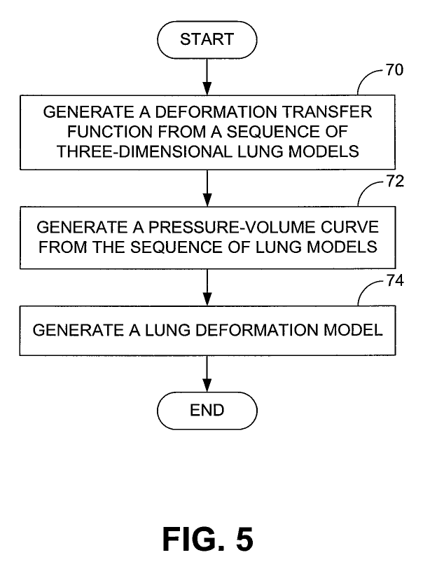

Referring next to FIG. 5, illustrated is an embodiment of a method for generating a model for simulating organ dynamics. More particularly, illustrated is an embodiment generating a model that simulates real-time lung dynamics in three dimensions. Beginning with block 70, a deformation transfer function is generated from a time sequence of three-dimensional lung models, such as those described in relation to FIG. 3. Next, with reference to block 72, a pressure-volume curve is generated from the time sequence of lung models. Finally, at block 74, a lung deformation model is generated that can be used to predict deformation of the lungs of a patient during breathing.

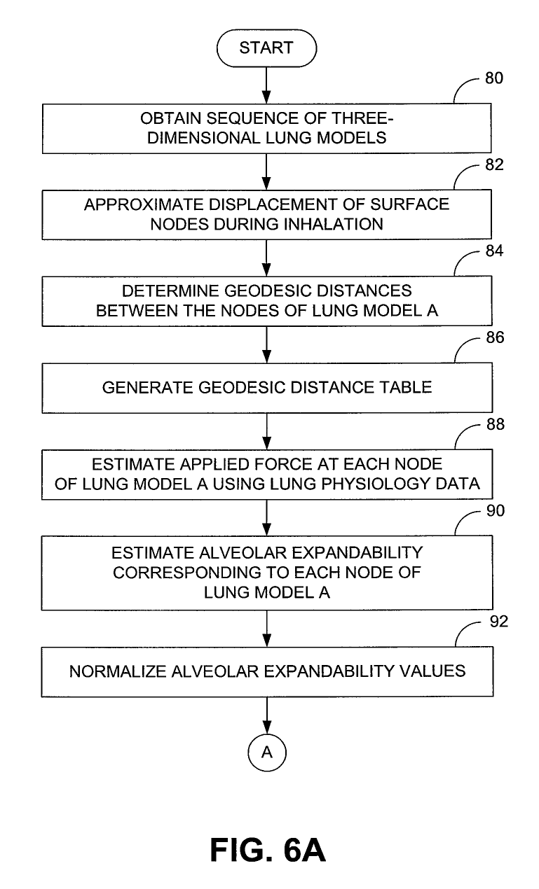

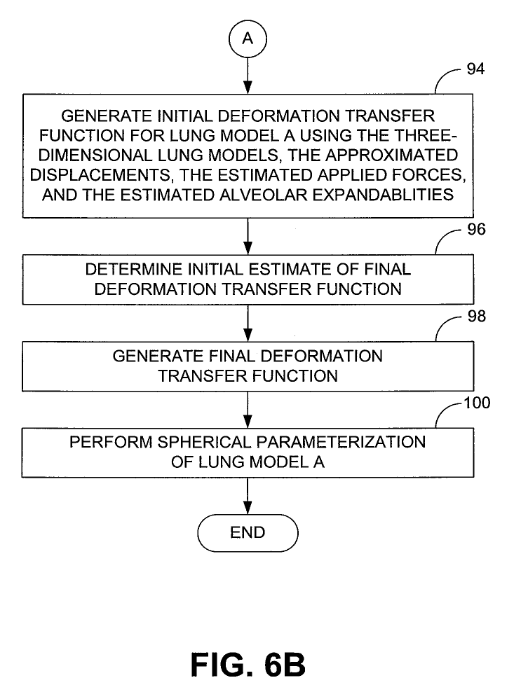

Reference is now made to FIGS. 6A-6B, which comprise a flow diagram of an embodiment of a method for generating a deformation transfer function, as indicated in block 70 of FIG. 5. Beginning with block 80 of FIG. 6A, a time sequence of three-dimensional lung models, for example those generated through the method described in relation to FIG. 3, are obtained. As described above, the three-dimensional lung models can comprise polygonal models generated from discrete CT scans of the lungs. Multiple three-dimensional lung models are obtained that represent a time sequence during patient breathing. In the following, it is assumed that the model time sequence relates to inhalation from an initial state in which the lungs have a relative minimum volume (i.e., fully exhaled during normal breathing) to a final state in which the lungs have a relative maximum volume (i.e., fully inhaled during normal breathing), often referred to as the “tidal” volume.

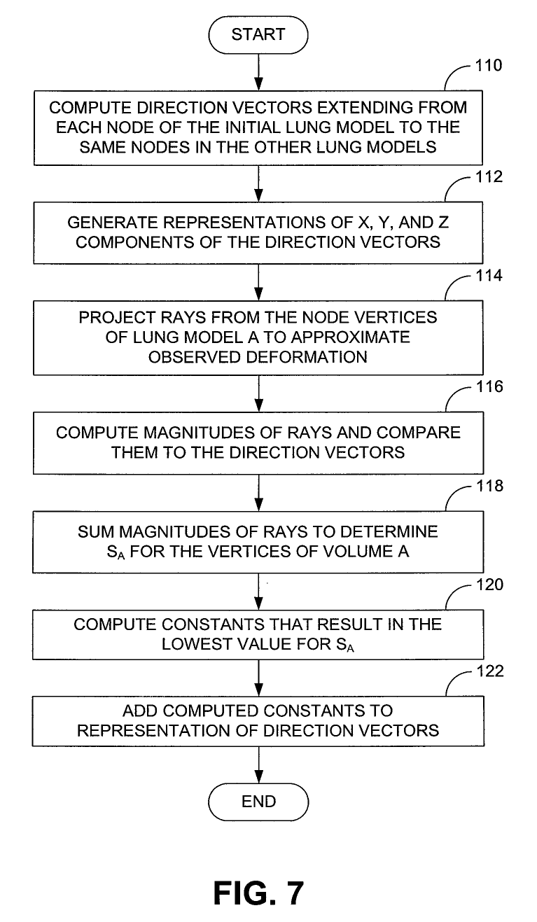

Next, the displacement of the surface nodes through the inhalation process can be approximated, as indicated in block 82. FIG. 7 describes one example method for estimating the displacement of the nodes. Beginning with block 110 of that figure, a direction vector is computed for each node, or vertex, extending from the initial state lung model, which shall be referred to henceforth as “lung model A,” at which the lungs have the relative minimum volume through the same nodes in the other lung models that reflect expansion of the lung through inhalation. By way of example, the linearity in the alveolar surface area as the lung volume is increased can be used to compute the direction vectors and determine the observed movement of multiple points of the lung surface during breathing.

With reference to block 112, the x, y, and z components, diX, diY, and diZ, of each direction vector, i, can be represented by the following equations:

$$\begin{matrix}diX = c 1 \times {( \frac{pi \cdot X - min \cdot X}{max \cdot X - min \cdot X} )}^{c 2} & EQUATION 1 \\ diY = c 3 \times {( \frac{pi \cdot Y - min \cdot Y}{max \cdot Y - min \cdot Y} )}^{c 4} & EQUATION 2 \\ diZ = c 5 \times {( \frac{pi \cdot Z - min \cdot Z}{max \cdot Z - min \cdot Z} )}^{c 6} & EQUATION 3\end{matrix}$$

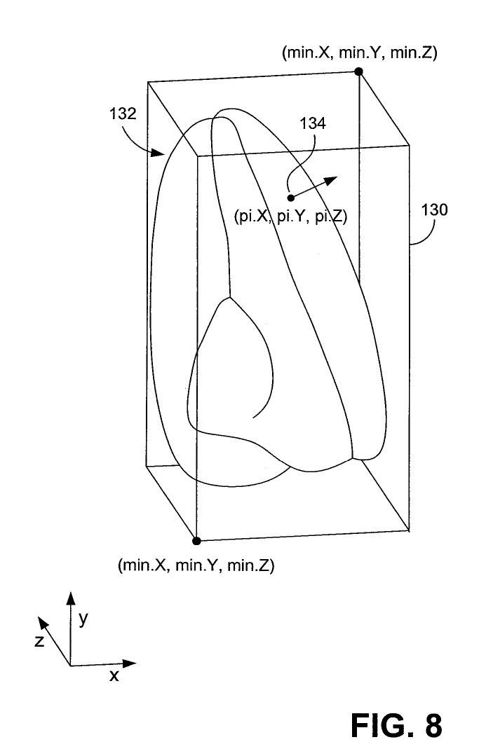

In those equations, the lung models can be considered as being fit within a hypothetical box that defines a coordinate system having minimum coordinates min.X, min.Y, and min.Z and maximum coordinates max.X, max.Y, and max.Z. In that system, the vertex, i, of each node has the coordinates pi.X, pi.Y, and pi.Z. Such a configuration is schematically represented in FIG. 8 in which the hypothetical box 130 is sized to have dimensions that are just large enough to contain a lung model 132. In that figure, only one vertex 134 is shown for purposes of illustration.

The values of pi.X, piY, and piZ can be obtained from a table that tabulates the positions of each node in each model once the models have been generated, and the values of min.X, min.Y, min.Z, max.X, max.Y, and max.Z are known once the box 130 has been constructed. The constants c1, c2, c3, c4, c5, and c6 of Equations 1-3 are initially unknown, but can be computed for discrete conditions to refine the modeling of lung deformation. For example, the constants can be determined for conditions that may include, for example: a human subject lying supine or sitting; an emphysema patient lying supine or sitting; a lung tumor patient lying supine or sitting; etc. In that manner, the constants can be used to take into account the effects of gravity and/or physiological condition of the patient when later generating a simulation of lung dynamics.

Next, the values of c1-c6 are computed. For a given initial set of values of c1-c6, rays, rᵢ are generated and projected from each vertex, i, of the lung model A to approximate the observed direction vectors, as indicated in block 114. The magnitudes of each of the projected rays are then computed and compared to the observed direction vectors, as indicated in block 116, so as enable determination as to which rays best approximate the actual deformations observed from the polygonal lung models. The magnitudes of the rays for each node will yield an RMS variation of the measured distances. Next, the summation, S_{A}, of rᵢ for the vertices of model A is calculated, as indicated in block 118. At that point, the constants, c1-c6, can be computed to identify values that result in the lowest value for S_{A}, as indicated in block 120. By way of example, a depth-first search algorithm, or equivalent, can be used in which initial values are assumed for the constants, vectors computed using Equations 1-3, and the results compared to the actual observed lung deformations. Therefore, the constants can be indexed until a combination of constants is determined that yields the minimum value of S_{A}. Through such a process, the pertinent values for each constant in each state (e.g., healthy, diseased, etc.) can be generated. Notably, in determining the constants, lung expansion is assumed to be linear such that, for example, the displacements of all nodes from 5% of the tidal volume to 40% of the tidal volume are assumed to be proportional to the displacements from 40% of the tidal volume to 75% of the tidal volume. Through the above-described computations, the constants that reflect the most linear behavior for lung expansion are selected.

Once the constants have been computed, they can be added to the above-described vector relations, as indicated in block 122, to provide an approximation for displacement of the surface nodes. By way of example, the following constants were generated using the above-described process for a healthy left-side lung in the supine position:
c1=0.09 c4=0.5
c2=0.23 c5=−0.1
c3=0.4 c6=2.3

Returning to FIG. 6A, the next step in the exemplary method for generating a deformation transfer function is determining the geodesic distances between the nodes of lung model A, as indicated in block 84. The geodesic distances reflect the shortest paths between the nodes along the surfaces of the models and are used to estimate the effect of displacement of each node relative to adjacent nodes and therefore the local interaction of the nodes. Once the distances have been determined, a geodesic distance table is constructed for lung model A, as indicated in block 86. In some embodiments, the geodesic distance table is generated by computing a new three-dimensional lung model B from lung model A. Lung model B is similar to lung model A except that it has a lower model resolution. The geodesic distance between any two nodes i_{A} and j_{A} in lung model A is computed by (i) computing the distances of i_{A} and j_{A} with a nearest point in lung model B, i_{B} and j_{B} respectively, (ii) computing the geodesic distance between the i_{B} and j_{B} from the distance vector table, and (iii) summing all the distances (Euclidean distance between i_{A} to i_{B}, geodesic distance between i_{B} to j_{B}, Euclidean distance between j_{B} to j_{A}). In some embodiments, the above, can be performed using third-party commercial software.

Next, an applied force at each surface node of lung model A is estimated using lung physiology data corresponding to human subject data sets, as indicated in block 88. The human subject data can include normal and abnormal subject data. In some embodiments, estimating the force applied at each surface node is performed by computing the bounding box of a given polygonal model. In this manner, minimum and maximum values are determined as the bounding vectors. The applied force is computed based on a given lung orientation as it relates to the effect of the gravitational force. By way of example, the z direction can be designated to be the direction of gravitational force for the supine position. The variables p(i) and f(i) can be designated to represent the position and force applied on each node, respectively. The force is then calculated according to the following expression:
f(i)=((p(i).Z−min.Z)/(max.Z−min.Z)) EQUATION 4
After f(i) is calculated for each vertex of lung model A, the values are normalized such that the sum of the force applied is equal to a unit increase in volume. Referring again to FIG. 6A, the next step in the exemplary method for generating a deformation transfer function comprises estimating the alveolar expandability corresponding to each surface node of lung model A using lung physiology that corresponds to human subject data, as indicated in block 90. The alveolar expandability can be calculated by computing the bounding box (see FIG. 8) of the given polygonal model, where the minimum and maximum are the bounding vectors. Where y is the direction that extends from the apex to the base of the lungs, p(i) and e(i) can be designated as the position and the alveolar expandability, respectively, associated with each node i. The alveolar expandability, e(i), can be calculated using the following equation:
e(i)=((P(i).Y−min.Y)/(max.Y−min.Y))² EQUATION 5
Referring next to block 92, the values of e(i) are normalized such that the maximum value of e(i) equals 1.

Using the three-dimensional lung models, the approximated node displacements, the estimated applied forces, and the estimated alveolar expandabilities, an initial deformation transfer function of the lung model A, i.e., the lung model at the lowest air volume, is generated, as indicated in block 94 of FIG. 6B. The following presents one embodiment of generating such a deformation transfer function.

Deformation of the lung can be estimated using forward dynamics. To that end, data regarding the elasticity of the lungs and pressure-volume relationship data for the lungs can be used as inputs in the determination of the deformation of the lungs. For every node i on lung model A, a neighbor node j is chosen such that d(i,j) is the Euclidean distance between i and j. For each link between the two nodes, a spring node is assigned. A value of Young's modulus is assigned for each node based on the regional alveolar expansion value. An initial estimation of the transfer function, tₑ, is then computed. The estimated transfer function, tₑ, can be represented as a matrix such that row i in column j of the matrix is denoted by Tₑ[j→i]. The Euclidean distance between nodes i and j can be denoted by the function DIST(j,i) and the initial value of all matrix elements can be set to zero. For each immediate neighbor j of node i, the following expression is used to evaluate the elements in the matrix:

$${T}_{e} [ j \to i ] = {T}_{e} [ j \to i ] + ( \frac{{S}_{I}}{{\sum }_{1 - 0}^{Unknown ( f )} \times ( \frac{I}{Dist ( i , j )} )} ) \cdot \frac{1}{Dist ( j , i ) )} \qquad EQUATION 6$$

For every other node, k, which can be reached from node j through i, the transfer function can be estimated using the following expression:
Tₑ[j→k]=Tₑ[j→k]+Tₑ[j→i]×Tₑ[i→k] EQUATION 7

After the initial estimation of the transfer function is computed, an initial estimate of a final transfer function, T_{f}, is determined, as indicated in block 96 of FIG. 6B. This is accomplished by assigning accumulators (floating-point variables) for each node of lung model A. The accumulators are configured such that each node includes a Catcher accumulator and Pitcher accumulator. The Pitcher accumulator is initialized to the applied force and the Catcher accumulator is initialized to zero. The Pitcher accumulator of each node's neighbor is updated by adding the product of that node's Pitcher accumulator to the estimated transfer function between i and j. The Pitcher accumulator for each node's neighbor is subtracted from the node's Pitcher accumulator, and the Catcher accumulator of the node is updated by adding to it the remaining node's Pitcher accumulator. Then the i node's Pitcher accumulator is set to zero. This procedure is repeated for each node until all the values of the Pitcher accumulator for every node equal zero. The final transfer function T_{f} is estimated using the applied force, f, the estimated transfer function, Tₑ, and the computed value of Catcher accumulator according to the following expression:

$${T}_{f} [ j \to i ] = ( \frac{Catcher [ j ]}{f [ j ]} ) \times {T}_{e} [ j \to i ] \qquad EQUATION 8$$

Next, the computed T_{f} is designated as T_{f1} and the geodesic distance between nodes are increased by, for example, a factor of two and the transfer function is recomputed. Doubling the internodal distances enables one to see the effect of those distances on the transfer function. The re-computed T_{f1} is then designated as T_{f2}. Next, for each vertex of the lung model A, constants gᵢ and hᵢ are computed using forward dynamics. Those constants represent the effect of geodesic distances and the alveolar expandability on the deformation transfer function. For every vertex i, gᵢ and hᵢ can be computed according to the following equations:
gᵢ=(T_{f}_{₂}[i→j]−T_{f}_{₁}(i→j))/(d(i, j)) EQUATION 9
hᵢ=T_{f}_{₁}×[i→j]−E×d(i,j) EQUATION 10

After the constants gᵢ and hᵢ have been computed for each node, an effective distance d (j,i) for every neighbor j can be computed according to the following expression:
d′(j,i)=gᵢ×d(j,i)+hᵢ(j,i) EQUATION 11
Using the effective distance, a polar distance function z′(j,i) can be computed as:

$${z}^{′} ( j , i ) = [ {cos}^{- 1} ( \frac{1}{4 π {d}^{′} ( j , i )} ) ] \qquad EQUATION 12$$

The final transfer function, T_{F}, for the lung model A is then generated, as indicated in block 98. T_{F} can be computed using the following expression:
T_{F}[j→i]=C_{I}cos z′(j,i) EQUATION 13
where C_{I} is a proportionality constant that is used to reflect condition-specific data and is computed for a known displacement d[i] by the following expression:

$${C}_{I} = \frac{d [ i ]}{{\sum }_{j = 0}^{N} f [ j ] \times cos ( {z}^{′} ( j , i ) )} \qquad EQUATION 14$$

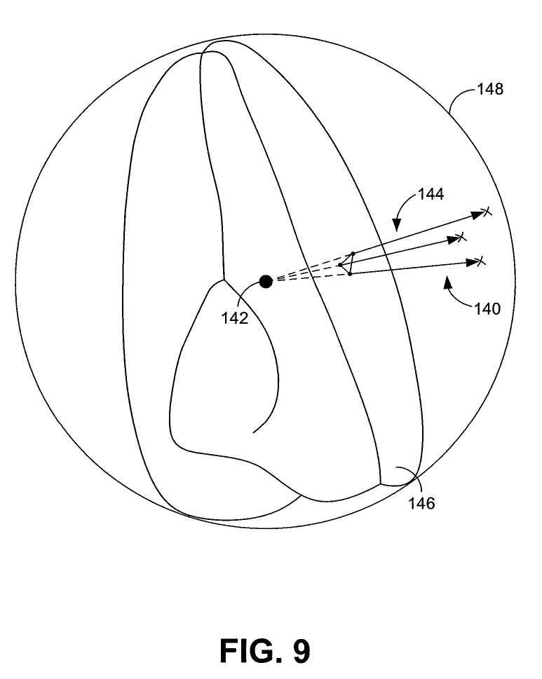

After the transfer function, T_{F}, is computed, a spherical parameterization of lung model A can be performed, as indicated in block 100, to simplify rendering of images during lung simulation. In some embodiments, this involves calculating the spherical harmonic coefficients of each row of the transfer function and providing those coefficients to a graphics processing unit that will render images in the simulation. In some embodiments, the parameterization is performed by computing the centroid of the lung model A and generating a ray for each vertex that originate from the centroid, passes through the vertex, and intersects a hypothetical spherical hull that surrounds the lung model. Such a process is schematically depicted in FIG. 9. Shown in that figure are rays 140 that extend from the centroid 142, pass through vertices 144 on the surface of the lung model 146, and intersect the spherical hull 148. The spherical coordinates are computed based on the intersection between the rays and the corresponding points on the spherical hull 148.

Spherical Harmonic (SH) coefficients of each row of the transfer function for a given value of i are computed as the summation of the products of the SH coefficients of j and the transfer function row element indexed by j. The SH coefficients are then stored along with the vertexes, direction of displacement, and normals of the lung model A in memory, for example of a graphics processing unit.

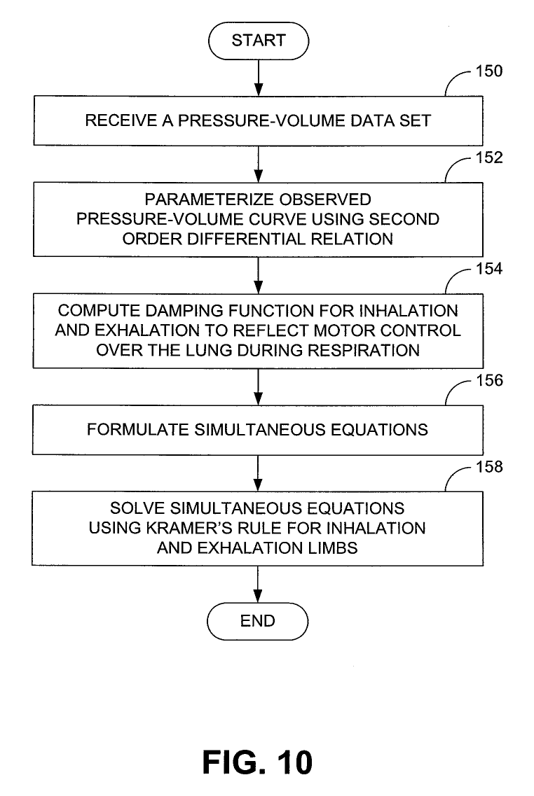

With reference back to FIG. 5, the method for generating a model for simulating organ dynamics also includes generating a pressure-volume (PV) curve for a lung in block 72. The PV curve can be used as an input that reveals the pattern of lung inhalation and exhalation. An observed PV curve can be generated from discrete PV data points collected from actual subjects during breathing or, in the alternative, a set of control constants can be received that together with a second order differential relation of the PV curve represents the parameterized PV data set corresponding to a statistically average human subject. In some embodiments pressure and volume data can be collected from multiple subjects as representative of multiple different conditions (e.g., standing healthy patient, etc.). An example method for generating a PV curve from a data set is illustrated in FIG. 10. As indicated in that figure, a PV data set is received (block 150) and the observed PV curve is parameterized using a second order differential relation (block 152). The parameterization of the PV curve is performed by first normalizing the data points of the curve for both the inhalation and exhalation limbs of the PV relation. Turning to block 154, a damping function can be computed for each inhalation and exhalation using to the following expression:
D[t]=(F_{—}E[t]+A[t−1]−F_{—}T[t])/Ve[t−1] EQUATION 15
where Ve and A are the first and second order differential volume respectively, F_E is the step increase in the applied force, and F_T is the total force at discrete time instant t. The damping function can be used as a control parameter that reflects the brain or “motor” control over the lungs during breathing and the limiting of “damping effect” that control has. After computing the damping function, simultaneous equations can be formulated, as indicated in block 156, according to the following expression:

$$D [ i ] = {\sum }_{j = 1}^{N} {\sum }_{k = ′}^{( N - 1 ) / 2} ( 1 - \frac{( {x}_{j}^{q} {{sin}^{2} ( \frac{i}{T} \times π \times g ( k , j ) )}^{2 / q}}{{( g ( k , j ) )}^{2}} ) \qquad EQUATION 16$$

where q represents a measure of motor control. The PV control constants, xᵢ and xⱼ, in the simultaneous equations are solved using Kramer's rule for both the inhalation and exhalation limbs, as indicated in block 158. With PV control constants and the motor drive, q, any PV curve can be simulated that corresponds to any given condition (e.g., standing healthy patient, etc.).

The PV curve can be calculated by first calculating the volume of lung at time instant, t, using the following equation:
V[t]=V[t−1]+Ve[t−1]+0.5×A[t−1] EQUATION 17
where Ve and A are computed as
Ve[t]=Ve[(t−1)]+A[t−1]×(Δi) EQUATION 18
A[i]=F_{—}T[i]M EQUATION 19
The value of Ve and A at t≦0 is set to be 0. The value of F_T[t] is computed for the given set of control constants from equation 15. The value of F_E[t] at time instant t is set to be in linear increments of a constant. The data points of the both the inhalation and exhalation limbs of the PV relation are normalized and the volume range is adjusted to fit the required tidal volume.

Assume pⁱ, qⁱ, and rⁱ are the arrays of pre-computed SH coefficients for the applied force at rotation angle i of π/2, π, 3π/2, and 2π along the X, Y, and Z axes, respectively, and further assume a, b, and c be arbitrary valves for current rotation angles for the three-dimensional lung model. For such an orientation, the SH coefficients for the applied force are computed by smoothly interpolating among pⁱ, qⁱ, and rⁱ. Next, assume a₀, a₁, b₀, b₁, c₀, and c₁ are the angles of i that form the closest lower and upper limits for a, b, and c, respectively. The SH coefficients of the applied force for the orientation a, b, and c are now given by
f^{abc}l=f^{a}l+f^{b}l+f^{c}l EQUATION 20
where
f^{a}ₗ=[pₐ^{₀}×cos(a−a₀)+pₗ^{a}^{₁}×cos(a−a₁) EQUATION 21
f^{b}ₗ=[qₗ^{b}^{₀}×cos(b−b₀)+qₗ^{b}^{₁}×cos(b−b₁)] EQUATION 22
and f^{c}ₗ=[rₗ^{c}_{₀}×cos(c−c₀)+rₗ^{c}^{₁}×cos(c−c₁)] EQUATION 23

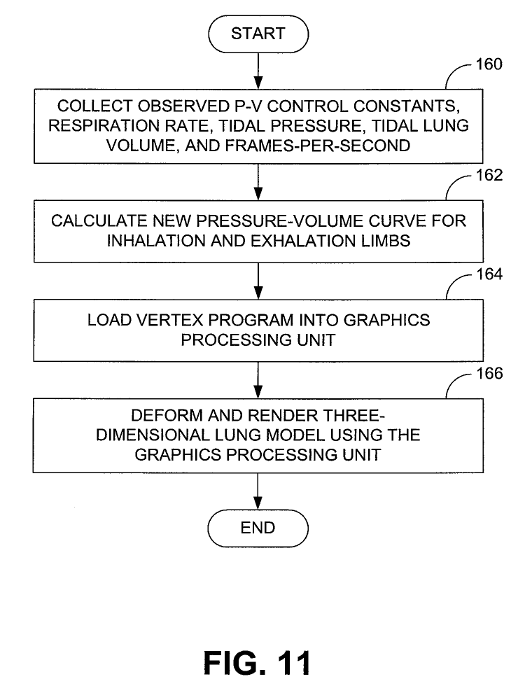

Returning again to FIG. 5, the method for simulating organ dynamics further includes generating (e.g., rendering) a lung deformation model. Such a model can be used to simulate the deformation of a given patient's lungs during respiration to provide a visualization tool that may be used as a diagnostic aid by a physician or other technician. An embodiment of a method for rendering such a model is illustrated in FIG. 11. Beginning with block 160 of that figure, observed PV control constants for a patient, the respiration rate, the tidal pressure, tidal lung volume, and the frames-per-second are collected. Next, a new PV curve is calculated for each of the inhalation limb and the exhalation limb, as indicated in block 162. A vertex program that is capable of computing the displacement of each node as a dot product of the SH coefficients of the applied force and the SH coefficients of the transfer function row is then loaded into a graphics processing unit, as indicated in block 164. By way of example, the vertex program comprises the three-dimensional deformable lung model generated from the lung deformation model generator 42 (FIG. 2). For every breathing cycle the control constants for the PV curves and the given angles of orientation for the lungs, the SH coefficients of the applied force are estimated. For an increase in the lung volume from the PV relation computed from the input PV control constants, the three-dimensional lung model can then be deformed and rendered on a display (e.g., display 30 of FIG. 2) showing a unit increase in the three-dimensional lung volume computed by the PV relation, as indicated in block 166.

We claim:

1. A method for simulating organ dynamics, the method comprising:
generating a sequence of three-dimensional models of an organ during different stages of observed dynamic motion;
generating a deformation transfer function from the sequence of three-dimensional models;
generating a pressure-volume curve from the sequence of three-dimensional models; and
generating an organ deformation model that simulates dynamic motion of the organ.

2. The method of claim 1, wherein generating a sequence of three-dimensional models comprises generating a sequence of three-dimensional models of a lung during inhalation or exhalation.

3. The method of claim 1, wherein generating a sequence of three-dimension models comprises capturing two-dimensional cross-sectional images of the organ that are combined to form the three-dimensional models.

4. The method of claim 1, wherein generating a sequence of three-dimension models comprises generating a polygonal model of the organ that includes a plurality of surface nodes that are interconnected with links.

5. The method of claim 4, wherein generating a deformation transfer function comprises approximating displacement of the surface nodes of the three-dimensional models during the observed dynamic motion.

6. The method of claim 5, wherein generating a deformation transfer function further comprises determining geodesic distances between nodes of an initial state model, the initial state model being the three-dimensional model associated with an the initial state of the observed dynamic motion.

7. The method of claim 6, wherein generating a deformation transfer function further comprises estimating an applied force at each node of the initial state model using lung physiology data.

8. The method of claim 7, wherein generating a deformation transfer function further comprises estimating an alveolar expandability value for each node of the initial state model.

9. The method of claim 8, wherein generating a deformation transfer function further comprises normalizing the alveolar expandability values.

10. The method of claim 9, wherein generating a deformation transfer function further comprises generating an initial deformation transfer function for the initial state model from the three-dimensional models, the approximated displacement, the estimated applied forces, and the estimated alveolar expandability values.

11. The method of claim 10, wherein generating a deformation transfer function further comprises generating a final deformation transfer function from the initial deformation transfer function.

12. The method of claim 11, further comprising performing spherical parameterization for the initial state model.

13. The method of claim 1, wherein generating a pressure-volume curve comprises receiving observed organ pressure-volume data and parameterizing the data using a second order differential relation.

14. The method of claim 13, wherein generating a pressure-volume curve further comprises computing a damping function that reflects motor control over the organ during motion.

15. The method of claim 14, wherein generating a pressure-volume curve further comprises solving simultaneous equations using Kramer's rule to obtain the pressure volume curve.

16. The method of claim 1, wherein generating an organ deformation model comprises rendering the model as a visual indication of deformation of the organ during motion.

17. A system for simulating organ dynamics, the system comprising:
means for generating a deformation transfer function from a sequence of three-dimensional models reflective of various stages of observed motion;
means for generating a pressure-volume curve from the sequence of three-dimensional models; and
means for generating an organ deformation model that simulates dynamic motion of the organ.

18. The system of claim 1, wherein the means for generating a deformation transfer function comprise means for approximating displacement of surface nodes of the three-dimensional models during the observed motion.

19. The system of claim 18, wherein the means for generating a deformation transfer function further comprise means for determining geodesic distances between nodes of an initial state model, the initial state model being the three-dimensional model associated with an the initial state of the observed dynamic motion.

20. The system of claim 19, wherein the means for generating a deformation transfer function further comprise means for estimating an applied force at each node of the initial state model using lung physiology data.

21. The system of claim 20, wherein the means for generating a deformation transfer function further comprise means for estimating an alveolar expandability value for each node of the initial state model.

22. The system of claim 9, wherein the means for generating a deformation transfer function further comprise means for generating an initial deformation transfer function for the initial state model from the three-dimensional models, the approximated displacement, the estimated applied forces, and the estimated alveolar expandability values.

23. The system of claim 17, wherein the means for generating a pressure-volume curve comprise means for receiving observed organ pressure-volume data and parameterizing the data using a second order differential relation.

24. The system of claim 23, wherein the means for generating a pressure-volume curve further comprise means for computing a damping function that reflects motor control over the organ during motion.

25. The system of claim 17, wherein the means for generating an organ deformation model comprise means for rendering the model as a visual indication of deformation of the organ during motion.

26. A computer-readable medium that stores a dynamic motion simulation system, the system comprising:
logic configured to generate a deformation transfer function from the sequence of three-dimensional models;
logic configured to generate a pressure-volume curve from the sequence of three-dimensional models; and
logic configured to generate an organ deformation model that simulates dynamic motion of the organ.

27. The computer-readable medium of claim 26, wherein the logic configured to generate a deformation transfer function comprises logic configured to approximate displacement of surface nodes of the three-dimensional models during the observed motion.

28. The computer-readable medium of claim 27, wherein the logic configured to generate a deformation transfer function further comprises logic configured to determine geodesic distances between nodes of an initial state model, the initial state model being the three-dimensional model associated with an the initial state of the observed dynamic motion.

29. The computer-readable medium of claim 28, wherein the logic configured to generate a deformation transfer function further comprises logic configured to estimate an applied force at each node of the initial state model using lung physiology data.

30. The computer-readable medium of claim 29, wherein the logic configured to generate a deformation transfer function further comprises logic configured to estimate an alveolar expandability value for each node of the initial state model.

31. The computer-readable medium of claim 30, wherein the logic configured to generate a deformation transfer function further comprises logic configured to generate an initial deformation transfer function for the initial state model from the three-dimensional models, the approximated displacement, the estimated applied forces, and the estimated alveolar expandability values.

32. The computer-readable medium of claim 23, wherein the logic configured to generate a pressure-volume curve comprises logic configured to receive observed organ pressure-volume data and parameterizing the data using a second order differential relation.

33. The computer-readable medium of claim 23, wherein the logic configured to generate a pressure-volume curve further comprises logic configured to compute a damping function that reflects motor control over the organ during motion.

34. The computer-readable medium of claim 26, wherein the logic configured to generate an organ deformation model comprises logic configured to render the model as a visual indication of deformation of the organ during motion.
